(19) United States
(12) Patent Application Publication
(10) Pub. No.: US 2024/0343108 A1
(43) Pub. Date: Oct. 17, 2024

(54) Drive System for All-Terrain Vehicle (ATV)

(71) Applicant: Louis Decuzzi, Brunswick, OH (US)

(72) Inventor: Louis Decuzzi, Brunswick, OH (US)

(21) Appl. No.: 18/749,299

(22) Filed: Jun. 20, 2024

Related U.S. Application Data
(63) Continuation-in-part of application No. 18/467,311, filed on Sep. 14, 2023, now Pat. No. 12,059,959.
Application No. 18/467,311 is a continuation of application No. 17/084,760, filed on Oct. 30, 2020, now Pat. No. 11,766,929.
(60) Provisional application No. 62/927,987, filed on Oct. 30, 2019.

(51) Int. Cl. B60K 7/00; B60K 1/04; B60K 17/04; B60K 17/12; B60K 17/22; B60L 15/20; B60L 50/60; B60L 53/22; B60Q 1/04; B60Q 1/20; B60Q 1/30; B60Q 1/34; B60Q 1/44; B60Q 5/00; B62D 21/18; B62D 61/06; B66D 1/12; H02K 7/00; H02K 7/116; H02K 11/00

(52) U.S. Cl. CPC B60K 7/0007; B60K 1/04; B60K 17/043; B60K 17/12; B60K 17/22; B60L 15/20; B60L 50/66; B60L 53/22; B60Q 1/04; B60Q 1/20; B60Q 1/30; B60Q 1/34; B60Q 1/44; B60Q 5/00; B62D 21/183; B62D 61/065; H02K 7/006; H02K 7/116; H02K 11/0094; B60K 2001/0405; B60K 2007/0038; B60L 2210/12; B66D 1/12

(57) ABSTRACT

A drive system for an all-terrain vehicle (ATV) including an electric motor; a gearbox; four wheel and tire assemblies; a battery; a control module; and a throttle device; the electric motor is electrically connected to, and configured to receive at least a first signal from the control module; the control module is electrically connected to, and configured to receive a charge from the battery; and the throttle device is electrically connected to, and configured to send a second signal to the control module; the electric motor is rotationally connected to the gearbox, wherein at least one drive shaft is rotationally coupled to the gearbox to rotationally connect the gearbox to the four wheel and tire assemblies.

### CROSS REFERENCES AND PRIORITIES

This application claims priority from U.S. application Ser. No. 18/467,311 filed on Sep. 14, 2023, which claims priority from U.S. application Ser. No. 17/084,760 filed on 30 Oct. 2020, which has issued as U.S. Pat. No. 11,766,929, and claims priority from U.S. Provisional Application No. 62/927,987 filed on 30 Oct. 2019, the teachings of each of which are incorporated by reference herein in their entirety.

### BACKGROUND

All-terrain vehicles, also known as ATVs, are used for a variety of purposes including personal recreation, safety patrols, search and rescue operations, and racing. ATVs come in many configurations including three wheel and four wheel variations. The typical ATV has a space frame chassis with an internal combustion engine mounted within the space frame to provide rotational force to the ATV's drive train which in turn rotates at least one of the ATV's wheel and tire assemblies.

Recently, efforts have been made to replace the internal combustion engines in many types of vehicles—such as cars and trucks—with an electric motor. These efforts have also been directed to ATVs.

One challenge faced when replacing internal combustion engines with electric motors centers around the use of batteries. Electric motors used in portable vehicles cannot be hard wired to an electrical grid due to the mobile nature of the vehicle. Accordingly, the vehicle must include a battery for providing electricity to the electric motor. Electric vehicle batteries must be of a relatively high voltage to provide sufficient electricity to the electric motor to allow the vehicle to travel a reasonable distance without having to recharge or replace the battery. This often results in batteries for electric vehicles having a large volume and weight, which is often incongruous with relatively small vehicles such as ATVs.

Early efforts to convert ATVs from internal combustion engines to electric motors have addressed this problem by mounting the battery outside of the space frame chassis. The typical mounting location is high above the rear axle. Given the relatively high weight of the battery, this can have significant negative ramifications for the ATVs handling characteristics and safety. The battery weight mounted at this location can give the ATV an unwanted high center of gravity, and provide a poor front to rear weight balance.

The need exists—therefore—for an improved drive system for an ATV which makes use of an electric motor powered by a battery.

### SUMMARY

Disclosed herein is a drive system for an all-terrain vehicle (ATV). The drive system comprises an electric motor, at least three wheel and tire assemblies, a primary battery, a control module, and a throttle device. The primary battery is located within at least two opposing frame rails of a chassis of the all-terrain vehicle (ATV).

The electric motor may be a three-phase electric motor. The electric motor may be rotationally connected to at least one of the wheel and tire assemblies. The electric motor may be electrically connected to, and configured to receive at least a first signal from the control module. The control module may be electrically connected to, and configured to receive a charge from the primary battery. The throttle device may be electrically connected to, and configured to send a second signal to the control module.

In some embodiments, the electric motor may be rotationally connected to at least two of the wheel and tire assemblies. In certain embodiments, the drive system may comprise four wheel and tire assemblies. The electric motor may be rotationally connected to each of the four wheel and tire assemblies. In certain embodiments, the electric motor may be rotationally connected to the wheel and tire assemblies by an electric motor gearbox which is rotationally connected to a driveshaft which is rotationally connected to a gearbox which is rotationally connected to an axle.

In some embodiments, the drive system may further comprise at least one device selected from the group consisting of a light, a horn, and a winch. The drive system may also further comprise a step down converter, a secondary battery, and a transducer. The step down converter, when present, may be electrically connected to, and configured to receive a charge for the second battery at a first voltage level. Each device of the at least one device may be electrically connected to, and configured to receive a signal from the step down converter at a second voltage level which is less than the first voltage level when a circuit between the device and the secondary battery is opened. The transducer may be electrically connected to the primary battery and the secondary battery to provide a recharging voltage to the secondary battery from the primary battery.

The at least one device, in certain embodiments, may comprise at least one light. The at least one light may be selected from the group consisting of at least one headlight, at least one tail light, at least one brake light, at least one turn signal light, at least one daytime running light, and at least one fog light.

In certain embodiments, the primary battery may be contained within a housing. The housing, when present, may have a first cuboid shape. In some such embodiments, the housing may include an extension protruding upward from a top surface of the first cuboid shape. The extension itself may have a second cuboid shape.

In some embodiments, the chassis may comprise a slideable drawer configured to receive the primary battery. In certain such embodiments, the slideable drawer may comprise a pair of opposing tracks. In some such embodiments, at least one of the pair of opposing tracks may comprise a friction reducing mechanism. The friction reducing mechanism may be at least one bearing. In some embodiments, the friction reducing mechanism may be at least one slide plate. The at least one slide plate, when present, may comprise a material selected from the group consisting of ultra high molecular weight polyethylene (UHMW) plastics, bronze, powdered metal, and Teflon®.

In certain embodiments the electric motor may be rotationally connected to the wheel and tire assemblies by a gear and chain drive connected to an axle. In other embodiments, the electric motor may be rotationally connected to the wheel and tire assemblies by a belt and pulley drive connected to an axle.

In some embodiments the primary battery may be a lithium battery. In other embodiments the primary battery may be a lead acid battery.

### BRIEF DESCRIPTION OF FIGURES

FIG. 1 is a block diagram of an embodiment of a drive system for an all-terrain vehicle (ATV).

FIG. 2 is a block diagram of a separate embodiment of a drive system for an all-terrain vehicle (ATV).

FIG. 3 is a perspective view of a chassis of an all-terrain vehicle with a battery in place for installation.

FIG. 4 is a perspective view of a chassis of an all-terrain vehicle with a battery installed therein.

FIG. 5 is a perspective view of an all-terrain vehicle having a drive system as described herein.

FIG. 6 is an exploded view showing further details of a drive system in an all-terrain vehicle.

FIG. 7 is a perspective view of a chassis and drive system in an all-terrain vehicle.

FIG. 8 is a perspective view of a chassis in an all-terrain vehicle.

### DETAILED DESCRIPTION

Disclosed herein is a drive system for an all-terrain vehicle. The drive system is described below with reference to the Figures.

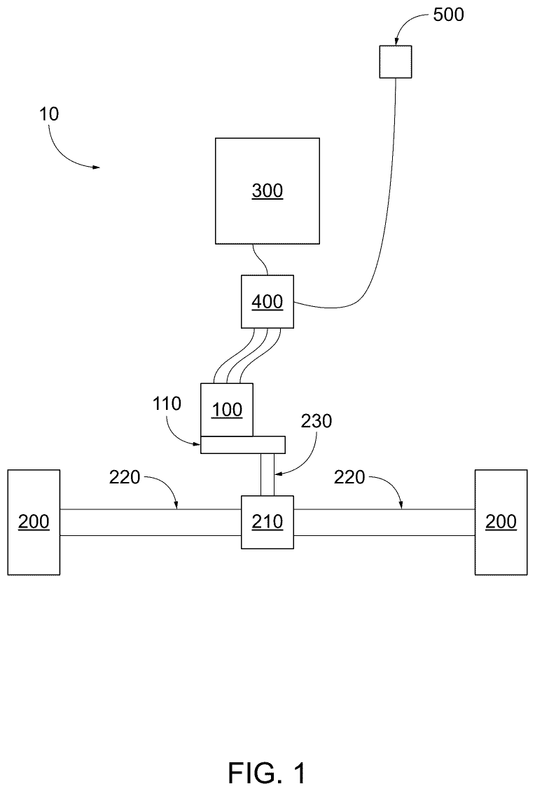

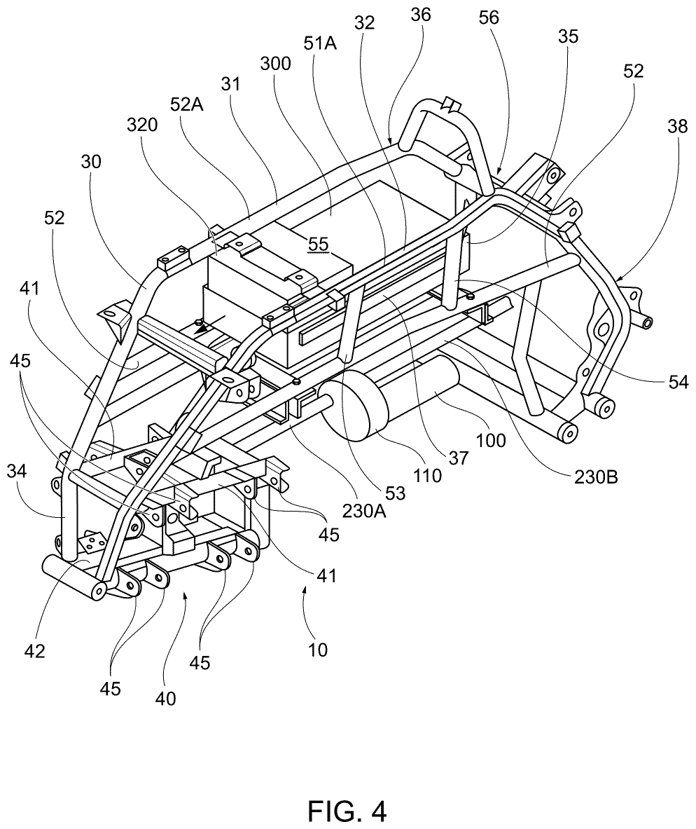

FIG. 1 depicts a block diagram of one embodiment of a drive system (10) for an all-terrain vehicle (ATV) (20 as shown in FIG. 4). As depicted in FIG. 1, the drive system may comprise an electric motor, at least three wheel and tire assemblies (200) (only two of which are shown in FIG. 1), a primary battery (300), a control module (400), and a throttle device (500). While FIG. 1 shows only two wheel and tire assemblies—many configurations of wheel and tire assemblies are possible, non-limiting examples of which are described below.

FIG. 1 also depicts the connections between the various components. As shown in FIG. 1, the electric motor (100) may be rotationally connected to at least one of the wheel and tire assemblies (200). The rotational connection may come in a variety of configurations.

In some embodiments, the ATV may be a three wheeled ATV with two wheel and tire assemblies in the front and a single wheel and tire assembly in the back. In such embodiments, the electric motor may be rotationally connected to the single wheel and tire assembly in the back by a gear and chain drive connected to an axle or by a belt and pulley drive connected to an axle.

In other embodiments, the ATV may be a three wheeled ATV with one wheel and tire assembly in the front and two wheel and tire assemblies in the back. In such embodiments, the electric motor may be rotationally connected to the two wheel and tire assemblies in the back by any number of mechanisms. One preferred mechanism—as shown in FIG. 1—is an electric motor gearbox (110) which is rotationally connected to a driveshaft (230) which is rotationally connected to a gearbox (210) which is rotationally connected to an axle (220). Examples of other mechanisms include a gear and chain drive connected to an axle, or a belt and pulley drive connected to an axle.

Four wheeled embodiments of ATVs are common with two wheel and tire assemblies in the front and two wheel and tire assemblies in the back. In such embodiments, the electric motor may be rotationally connected to the two wheel and tire assemblies in the back, the two wheel and tire assemblies in the front, or each of the four wheel and tire assemblies. Mechanisms for connecting the electric motor to the wheel and tire assemblies may include an electric motor gearbox which is rotationally connected to a driveshaft which is rotationally connected to a gearbox which is rotationally connected to an axle, a gear and chain drive connected to an axle, or a belt and pulley drive connected to an axle. In embodiments where the electric motor is rotationally connected to each of the four wheel and tire assemblies—there may be two mechanisms—one for connecting the electric motor to the two wheel and tire assemblies in the front and a second for connecting the electric motor to the two wheel and tire assemblies in the back, although the mechanism connecting the electric motor to the two wheel and tire assemblies in the front may share an electric motor gearbox with the mechanism connecting the electric motor to the two wheel and tire assemblies in the back.

FIG. 1 also shows the electric motor (100) electrically connected to, and configured to receive at least a first signal from the control module (400). The preferred electric motor is a three-phase electric motor. The electrical connection between the electric motor and the control module may comprise three separate electrical communication connections. Each electrical communication sends a signal in the form of amperage from the control module to the electric motor to activate one of the coils of the electric motor.

The control module (400) may be electrically connected to, and configured to receive a charge from the primary battery (300) as shown in FIG. 1. The charge from the primary battery will be in the form of voltage which is passed through the control module and transmitted to another device—such as the electric motor (100)—when the control module receives a signal to activate said other device—such as a signal from a throttle device (500).

FIG. 1 further depicts the throttle device (500) electrically connected to, and configured to send a second signal to the control module (400). The second signal indicates to the control module to pass voltage from the primary battery (300) to the electric motor (100) with the amount of voltage controlled by the amount of throttle input provided by the operator. Specific non-limiting examples of a throttle device include a pedal throttle, a thumb throttle, and a twist throttle
each of which are well known in the art.

The primary battery (300), is preferably a 72 volt 100 amp lithium battery. The lithium battery may be a lithium ion battery, a lithium polymer battery, or a lithium prismatic battery. While a lithium battery is preferred, other batteries are possible, including lead acid batteries.

The control module (400) draws amperage from the primary battery upon receiving a signal from the throttle device. The control module then passes said amperage to the electric motor. Preferably the amount of amperage transmitted to the electric motor is determined by the amount of user input into the throttle device. The preferred control module is a circuit board.

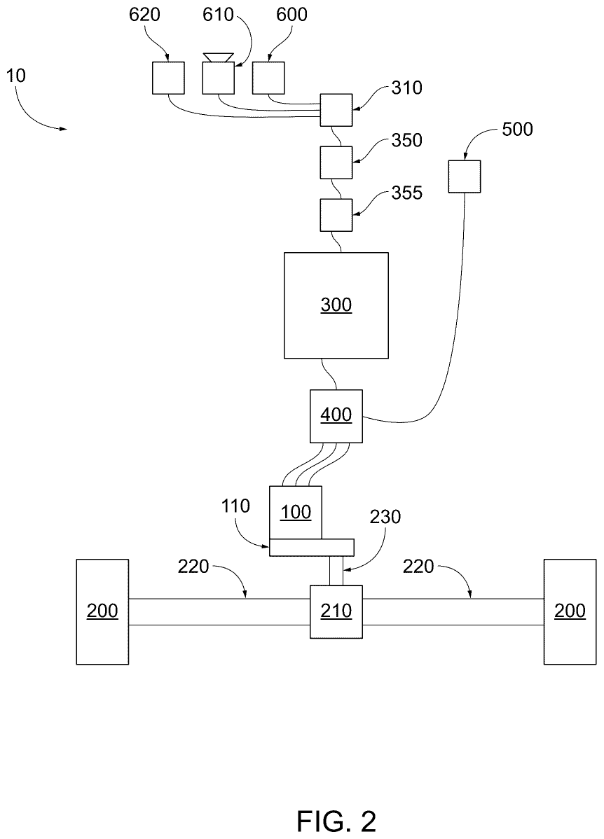

FIG. 2 depicts an embodiment of the drive system (10) showing additional features of the all-terrain vehicle (ATV). As shown in FIG. 2, the drive system may further comprise at least one device selected from the group consisting of a light (600), a horn (61), and a winch (620). The drive system may also further comprise a step down converter (310), a secondary battery (350), and a transducer (355).

As shown in FIG. 2, the step down converter (310) may be electrically connected to, and configured to receive a charge from the secondary battery (350) at a first voltage level. The step down converter then reduces the charge before sending the charge at a second voltage level (which is less than the first voltage level) to each device of the at least one device. In this regard, it is noted that each device of the at least one device may be electrically connected to, and configured to receive a charge from the step down converter.

The transducer (355) may be electrically connected to the primary battery (300) and the secondary battery (350) as shown in FIG. 2. This allows the secondary battery to be recharged by the primary battery through the transducer. In other words, the transducer provides a recharging voltage to the secondary battery from the primary battery.

Each device of the at least one device may be electrically connected to, and configured to receive a signal from the secondary battery (350) through the step down converter (310). This signal may be in the form of voltage from the secondary battery when a circuit between the secondary battery is opened, such as by a switch or button.

When the at least one device includes a light (600), the light may be in a variety of locations and may serve a variety of well-known functions. Common lights include at least one headlight, at least one tail light, at least one brake light, at least one turn signal light, at least one daytime running light, and at least one fog light.

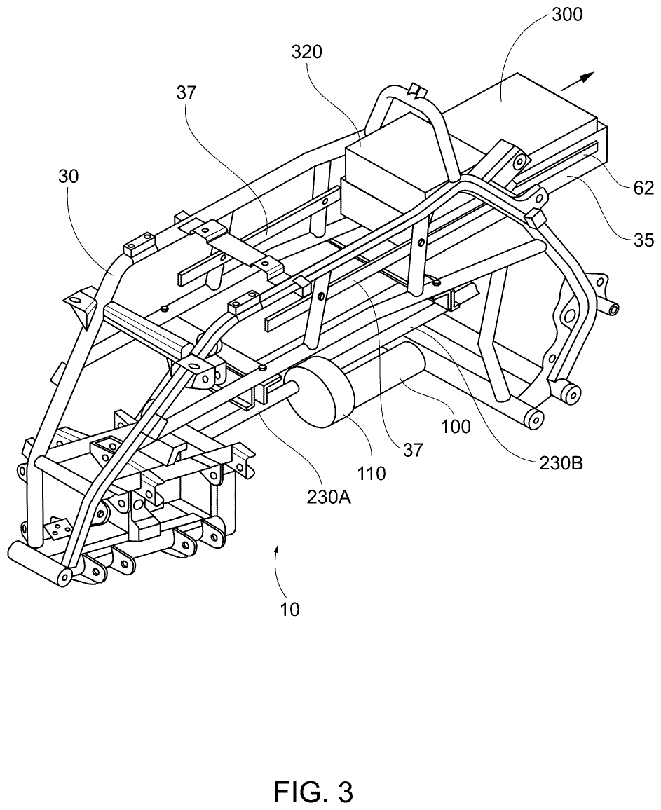

FIG. 3 depicts one embodiment of the primary battery (300) and chassis (30) of the all-terrain vehicle. As shown in FIG. 3, the primary battery may be contained within a housing (320). The housing may have a cuboid shape as shown in FIG. 3, although other shapes may be possible including a cube, a cylinder, a sphere, a spheroid, or any polyhedron having four or more faces.

In some embodiments, such as that shown in FIG. 3, the housing (320) may include at least one extension. When present, at least one of the extensions may protrude upward from a top surface of the cuboid shape of the housing. In certain embodiments, the extension itself may also have a cuboid shape, although other shapes may be possible including a cube, a cylinder, a sphere, a spheroid, or any polyhedron having four or more faces.

FIG. 3 also shows a removal system for the primary battery (300). The removal system may comprise a slideable drawer (35) configured to receive the primary battery. The slideable drawer may be connected to the chassis (30) within at least two opposing frame rails of the chassis. As shown in FIG. 3, the slideable drawer may comprise a pair of opposing tracks (37) similar to those used in toolbox or kitchen drawers.

In some embodiments, the pair of opposing tracks (37) may comprise a friction reducing mechanism. One example of a friction reducing mechanism is a bearing, which may be a ball bearing, or a roller bearing. Another example of a friction reducing mechanism is a slide plate. Slide plates may be comprised of a material selected from the group consisting of ultra high molecular weight polyethylene (UHMW) plastics, bronze, powdered metal, and Teflon®.

As shown in FIG. 3, the slideable drawer (35) has been extended at least partially out the rear of the all-terrain vehicle's chassis. While FIG. 3 shows the slideable drawer extending out the rear of the all-terrain vehicle's chassis, other configurations may exist in which the slideable drawer is configured to extend out the front of the all-terrain vehicle's chassis, or out of either side of the all-terrain vehicle's chassis. Once the slideable drawer has been extended, the primary battery (300) can be easily unplugged from the all-terrain vehicle's electrical system and removed from all-terrain vehicle for repair, replacement, or storage during times of non-use of the all-terrain vehicle.

FIG. 3 also shows the electric motor (100) located within at least two opposing frame rails of the chassis. The embodiment of the electric motor shown in FIG. 3 is configured for a four-wheel drive all-terrain vehicle in which the electric motor is rotationally connected to the two wheel and tire assemblies in the back of the all-terrain vehicle as well as the two wheel and tire assemblies in the front of the all-terrain vehicle. In the embodiment shown in FIG. 3, the electric motor is rotationally connected to the wheel and tire assemblies by an electric motor gearbox (110) which is rotationally connected to a pair of driveshafts (230A/230B) with the front driveshaft configured to be rotationally connected to a first gearbox which is rotationally connected to an axle which turns the wheel and tire assemblies in the front of the all-terrain vehicle, and the rear driveshaft configured to be rotationally connected to a second gearbox which is rotationally connected to an axle which turns the wheel and tire assemblies in the back of the all-terrain vehicle.

FIG. 4 depicts a perspective view of a chassis (30) of an all-terrain vehicle (ATV). As shown in FIG. 3, the primary battery (300) may be located within at least two opposing frame rails of the chassis. In the embodiment shown in FIG. 3, the primary battery is located within a housing which is configured to fit within the slideable drawer (35). Unlike in FIG. 3 where the slideable drawer is shown extended to allow the battery to be removed, in FIG. 4 the slideable drawer is retracted showing the battery in place where it resides during operation of the ATV. In some embodiments, once the slideable drawer is retracted, one or more latches or lock assemblies may hold the slideable drawer in place to prevent the slideable drawer from extending during operation.

As shown in FIG. 4, during operation the primary battery (300) may be located within at least two opposing frame rails of the chassis (30). While FIG. 4 shows the primary battery located within at least two opposing frame rails of the chassis in the approximate location of a fuel tank found in a traditional internal combustion engine powered ATV, other locations may be possible. For example, in some embodiments, the primary battery may be located in the approximate location of the engine found in a traditional internal combustion powered ATV.

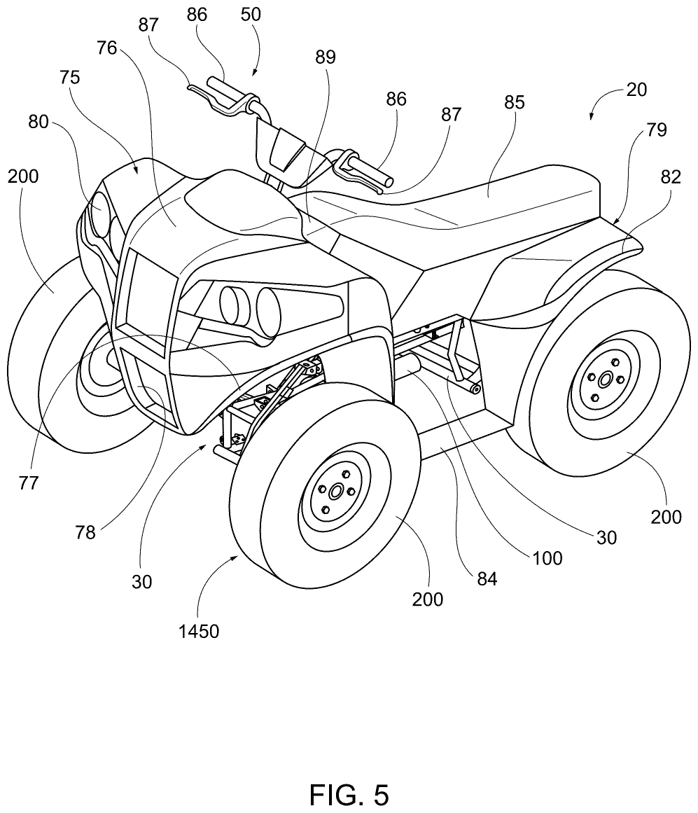

FIG. 5 depicts a perspective view of an all-terrain vehicle (20) including the drive system (10) disclosed herein. As shown in FIG. 4, the primary battery (300) may be located within at least two opposing frame rails of the chassis. In this case—and in FIG. 3—the chassis is a space frame chassis as found in most ATVs. However, other embodiments may exist in which the chassis is a ladder frame chassis, a unibody chassis, a backbone tube chassis, an X-frame chassis, a perimeter frame chassis, a platform frame chassis, or a subframe chassis.

With reference to FIG. 4, chassis (30) of an all-terrain vehicle (ATV) includes a first frame rail (31) and a second frame rail (32) spaced from each other by generally horizontally extending struts (33). Each frame rail (31,32) traces a somewhat arcuate shape extending upward from a forward end (34) of chassis to a saddle portion (36) and then downward rearward of the saddle portion to the rear end (38) of chassis (30). As shown, first and second frame rails (31,32) extend laterally outward from each other as they extend from forward end (34) toward saddle portion (36). First and second rails (31,32) run generally parallel to each other at saddle portion (36). The lateral spacing of first and second rails (31,32) at saddle portion is sufficiently narrow to allow a rider to straddle the saddle portion (36) riding with legs extending downward on either side of chassis (30). Rearward of saddle portion (36), first and second frame rails (31, 32) spread laterally apart relative to each other at rear end (38) of chassis (30).

At the forward end (34) of chassis (30), a suspension subframe generally indicated at (40) may be formed by upper and lower horizontally extending members (41,42) extending inward from frame rails (31,32). Each of the upper and lower members (41,42) of the suspension subframe (40) include plural tabs (45) to which suspension links are attached. As best shown in FIG. 5, a pair of wheel and tire assemblies may be suspended from the front end (34) of chassis (30). A handle bar, generally indicated at (50) is coupled to the front wheel and tire assemblies to provide steering inputs to the front wheels.

First and second cross supports (51,52) extend from the front end (34) of chassis (30) to rear end (38) of chassis (30). As shown, the cross supports (51,52) may extend rearward from front end (34) above suspension subframe (40) yet below saddle portion (36) of frame rails (31,32) to help support the arc formed by the frame rails (31,32) and stiffen chassis (30). In the example, the cross supports (51,52) extend rearward from front end (34) of chassis (30) generally parallel to each other along at least a portion of the saddle portion (36). In the example, cross supports (51,52) extend parallel to each other until reaching the center of saddle portion (36). From the center of saddle portion (36), the cross supports (51,52) extend laterally outward relative to each other until they intersect with the rear end (38) of chassis (30). As seen in FIG. 4, the lateral outward extension of the cross supports (51,52) causes the supports to pass under the saddle portion (36) of frame rails (31,32) at a point toward the rear of saddle portion (36).

Since the frame rails (31, 32) converge forward of saddle portion (36), the first portion (51A,52A) of cross supports (51,52) extending from the front end (34) lie laterally inward of first and second frame rails (31,32) at saddle portion. Struts (53, 54) may connect the frame rails (31, 32) to first portion of cross supports (51A,52A) at saddle portion with a first strut (53) extending upward and laterally outward at an angle from each cross support (51,52) to attach to a corresponding frame rail (31,32). First struts (53) connect to the parallel first portion (51A,52A) of cross supports (51,52) to the saddle portion of the frame rails (51,52) adjacent to the cavity (55) defined between the frame rails (31,32) and cross supports (51,52) at saddle portion (36) of chassis (30). A second strut (54) may connect a second portion (511B,52B) of cross supports (51,52) located where each cross support flares out below a frame rail such that strut (54) extends vertically between a cross support and a corresponding frame rail. Second strut (54) is also located adjacent to the cavity (55).

The slidable drawer (35) is positioned within cavity (55) defined between first and second frame rails (31,32); cross supports (51,52) and struts (53,54) at saddle portion (36). The spread of first and second frame rails (51,52) and cross supports (53,54) rearward of saddle portion (36) to rear end (38) provides a wider opening (56) behind slidable drawer (35) facilitating rearward extension of the slidable drawer (35) as depicted in FIG. 3 to remove the battery (300). As further depicted in FIG. 3, struts (53,54) may be used to support a pair of tracks on which the slideable drawer (35) is mounted.

As shown, tracks (37) may be attached inward of struts (53,54) extending relatively parallel to each other. Telescoping rails (62) may be provided on slideable slidable drawer (35) that fit over and slide on tracks (37). As shown, slidable drawer (35) slides rearward from saddle portion (36) of chassis (30) from cavity (55) through opening (56) such that it protrudes rearward of chassis (30) in a fully extended position (FIG. 3). In this position, the battery (300) is exposed in slidable drawer (35) facilitating its removal. When the slidable drawer (35) is slid inward in the direction of the arrow shown in FIG. 4, slidable drawer (35) advances inward of opening (56) housing slidable drawer (35) and the battery (300) centrally within chassis (30) distributing the weight of battery (300) evenly between the front end (34) and rear end (38). Positioning the battery (300) between rails (31,32); cross supports (51,52) and struts (53,54) forms a cage around the battery (300) to reduce the likelihood of damage to battery (300) in any impact or rollover situation.

With reference to FIG. 5, suitable bodywork, generally indicated at (75) may be attached to the chassis (30). The shape of the bodywork (75) includes a front portion or nose (76) having wheel arches (77) to accommodate front wheel and tire assemblies. One or more opening (78) may be provided within the nose (76) to route air into chassis (30) and toward battery (300) as the ATV is in forward motion. Additional airflow routing may occur at wheel arches (77). Bodywork (75) may include a rear portion or tail (79) that integrates rear wheel arches (82). Lights generally indicated at (80) may be provided on the front and rear portions of the bodywork (75), such as headlights, fog lights, daytime running lights, signal lights, tail lights and brake lights.

A foot platform (84) may extend between the forward wheel arch (77) and rear wheel arch (82). The foot platform (84) facilitates mounting of the ATV by providing a location for the user to step up on to the ATV and swing a leg over the saddle (85) of the ATV. The saddle (85) is supported on saddle portion (36) of chassis (30) above foot platform (84). As noted above, a rider sits upon saddle (85) with legs straddling the saddle (85) and extending downward on either side of chassis (30). The foot platform (84) provides a surface below saddle (85) on which a rider may rest their feet or apply foot pressure as needed in maneuvering the ATV. Handle bar (50) is located forward of saddle (85) and has a pair of grips (86) for the rider's hands. Brake handles (87) may be provided adjacent to grips (86) for ease of operation by hand while riding the ATV. The grips (86) provide an additional point to the foot platform (84) to which the rider may apply forces while riding for purposes of maintaining personal balance, taking an active role in weighting the suspension or changing the balance of the ATV during maneuvering. Locating battery (300) within chassis (30) below saddle (85) places the weight of battery (300) beneath the rider's seat and between their legs to provide improved feel and control of the weight of the ATV.

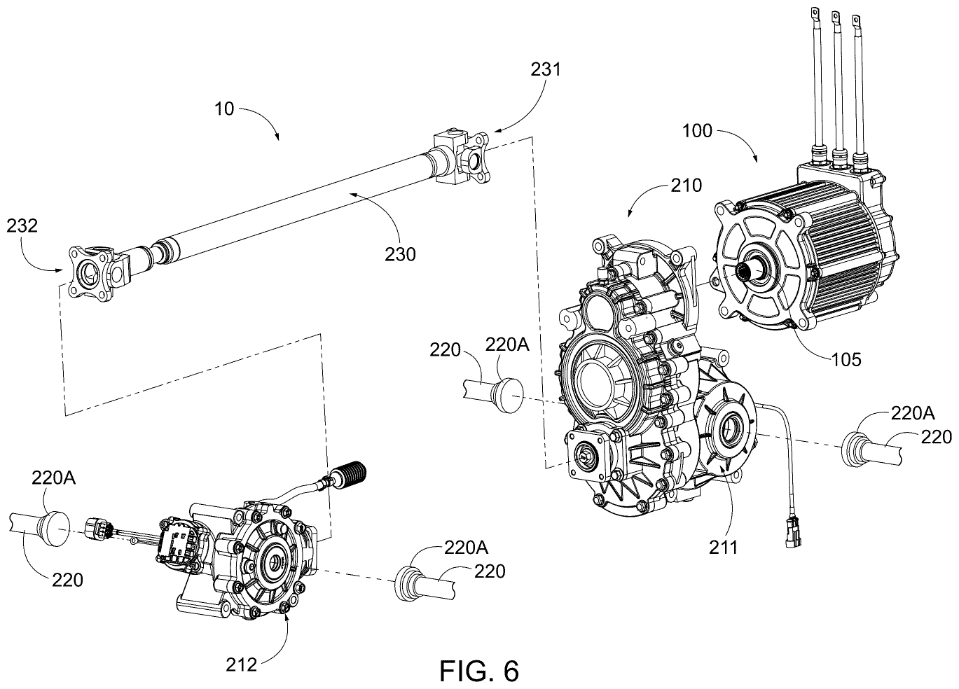

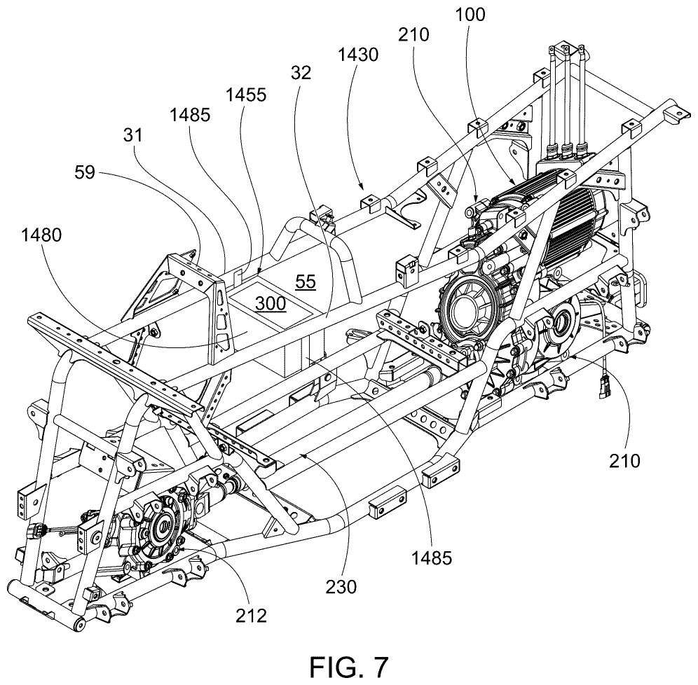

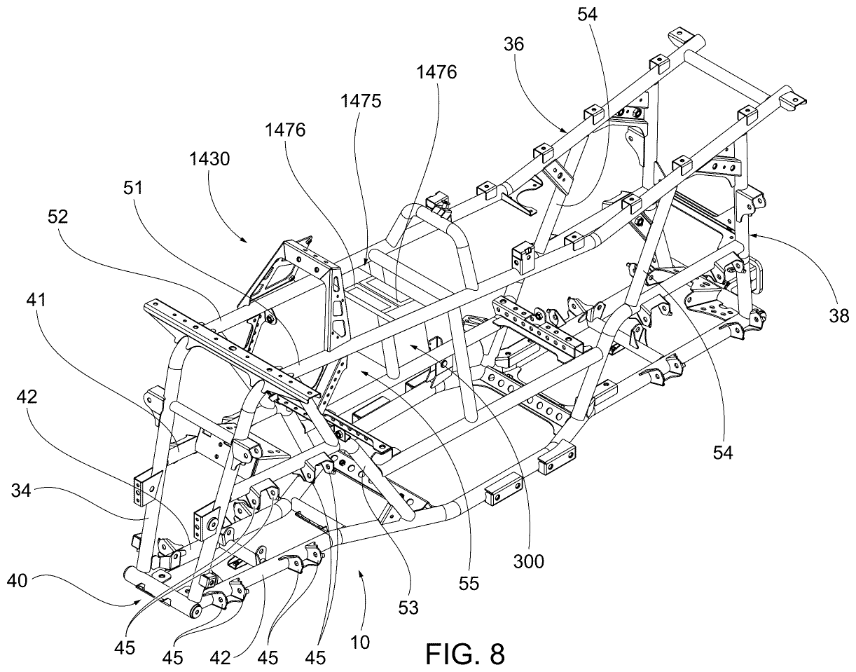

With reference to FIGS. 6-8, an all-terrain vehicle (ATV) (20) according to one example is shown. The example shows a drive system as described in connection with FIGS. 3 and 4 depicting further details of one example drive system. It will be understood that the drive system shown may be installed within the chassis (30) depicted in FIGS. 4 and 5 or other chassis configuration. The chassis (1430) shown in FIGS. 7 and 8 are, therefore, not limiting and the components shown and described above and parts from the various examples may be interchanged.

In general, ATV (20) includes a drive system (10) comprising an electric motor (100). The electric motor (100) may be rotationally connected to at least one propulsion assemblies (1450) to cause the ATV (20) to move. The propulsion assembly(ies) (1450) engage a medium including but not limited to a solid, liquid or gas to generate motion and may include propulsion members known in the art including wheels, tires, tracks belts, paddles, propellers, rotors, turbines and the like. Mediums that the propulsion system may interact with include but are not limited to earth, paved surfaces, gravel and other solid mediums; water and other liquids; and air and other gases. These examples are not limiting. In the example, propulsion assembly includes wheel and tire assemblies (200). The electric motor (100) is rotationally connected to the wheel and tire assemblies (200). The rotational connection may come in a variety of configurations as described above. Also, the propulsion assemblies may have various configurations as well.

With reference to the figures, a drive system (10) in a four wheeled example is shown. In such an example, the electric motor (100) may be rotationally connected to each of the four wheel and tire assemblies (200). Mechanisms for connecting the electric motor to the wheel and tire assemblies may include an electric motor gearbox which is rotationally connected to a driveshaft which is rotationally connected to a gearbox which is rotationally connected to an axle, a gear and chain drive connected to an axle, or a belt and pulley drive connected to an axle. In embodiments where the electric motor is rotationally connected to each of the four wheel and tire assemblies—there may be two mechanisms—one for connecting the electric motor to the two wheel and tire assemblies in the front and a second for connecting the electric motor to the two wheel and tire assemblies in the back, although the mechanism connecting the electric motor to the two wheel and tire assemblies in the front may share an electric motor gearbox with the mechanism connecting the electric motor to the two wheel and tire assemblies in the back.

With reference to FIGS. 6-8, one example of an electrically driven vehicle is shown. In the example, the electrical vehicle is an all-terrain vehicle (20) with a four wheel drive configuration. In the example shown, an electric motor (100) is attached to chassis (1430) at the rear of the ATV (20). The chassis (1430) is one example of a chassis and as indicated above, the drive system described in this example may be installed within chassis (30) shown in FIG. 4, and parts from each example may be interchanged to drive the four wheel and tire assemblies with electric motor (100) as discussed herein.

With reference to FIG. 8, Chassis (1430) may be constructed from one or more frame members as discussed in connection with chassis (30) including frame rails (31,32); struts (33,34) or in a unibody construction. In the example, chassis (1430) includes a pair of frame rails extending from a nose portion (34) to a rear portion (38). The frame rails (31,32) may include a saddle portion (36) to which the saddle or seat is attached as shown in FIG. 5. Various bodywork (75) may also be attached to chassis (1430) as depicted in FIG. 5. In general, the electric motor (100) may be located within the boundaries of the chassis (30, 1430). In FIGS. 7-8, electric motor (100) is located at the rear extremity of the chassis (30,1430). Electric motor (100) may be supported on frame rails (31,32) under the saddle portion (36).

With reference to FIGS. 6 and 8, a motor gearbox (210) is coupled to the electric motor (100) and located forward of the electric motor (100). A portion of the motor gearbox (210) extends downward relative to electric motor and is coupled to a first differential (211). The first differential (211) extends rearward from the gearbox (210) and below electric motor (100). Axles (220) are coupled to the first differential (211) and extend laterally outward therefrom to connect to a respective wheel and tire assembly (200). In the example, the first differential (211) is directly connected to motor gearbox (210), and the first differential (211) may be directly connected to the gear box housing to form a somewhat integral unit having a somewhat L-shaped configuration where the upstanding leg of the L receives the motor shaft (105) of electric motor with the lower leg of the L being formed by the first differential which extends rearward beneath the electric motor concentrating the weight of the electric motor and differential over the rear axles (220) of the ATV (20). This configuration is believed to provide advantages for applying an accelerating force as weight naturally shifts rearward in a suspended chassis configuration as shown.

A drive shaft (230) is coupled to gearbox (210) and extends forward from gearbox (210) to drive a wheel and tire assembly (200) at the front of the vehicle as described in more detail below. Drive shaft (230) couples to a second differential (212). Second differential (212) is attached to chassis (30) near the nose (34). Second differential (212) is coupled to at least one axle (220), which in turn is attached to a wheel and tire assembly (200). In the four wheel configuration shown, a pair of axles (200) extend laterally outward from second differential (212). In the example, axles (220) are coupled to second differential (212) by constant velocity (CV) joints (220A).

Drive shaft (230) may extend generally horizontally from gearbox (210) as shown, or extend at somewhat of an angle to couple to the second differential (212) depending on the relative height of second differential and/or wheel and tire assemblies that are connected via drive shaft (230). To that end, coupling of the drive shaft (230) may include a first universal joint (231) coupled to the gearbox (210) and a second universal joint (232) coupled to second differential (212). With reference to FIGS. 5 and 7, drive shaft (230) is located within the confines of chassis (30) and may extend through an area between the footwells of the bodywork (75).

The second differential (212) may, as shown, be located at the forward end (34) of the ATV (20). In the example, mounting points for the second differential are located near the front suspension attachment points or tabs (47). In the example, the mounting points place second differential (212) forward of handle bars (50) and over suspension assembly (40) for the forward wheel and tire assemblies (200).

Electrical connections are provided on electric motor (100) to electrically connect electric motor (100) to a power supply as described in the examples herein. With reference to FIG. 8, power supply includes a battery (300) supported within the chassis (1430). As described in the various examples, battery (300) may be made removable to facilitate replacement and/or charging. In FIG. 8, battery (300) is located within the cavity (55) defined by chassis (30, 1430) as is the case in other examples, and in accordance with the examples it is made to be removable from chassis (30,1430). For example, battery (300) is located within the chassis (30, 1430) in a location forward of saddle portion (36) and rearward of the steering assembly, for example rearward of a steering support (59) for the handle bar (50). In the example, a saddle support (39) may extend upward from frame rails (31,32) to provide an attachment point for the raised portion of saddle (85) best seen in FIG. 5. Chassis (30,1430) defines an opening (1455) between the steering support (59) and the saddle support (39) that opens upward from the chassis allowing access to the battery (300) from above the chassis (30,1450). This location allows access to the cavity (55) housing the battery (300), i.e. a battery compartment, defined within the chassis (30,1430) from the top of the chassis (30,1430). In the example, a battery cover (89) may be located forward of the saddle (FIG. 5) that can be removed to access the battery (300) and/or cavity (55).

To facilitate removal of the battery from cavity (55), at least one handle (1475) that may be grasped by hand or coupled to a lift may be provided. Handle (1475) may be any member that can be grasped by hand or a mechanical device to facilitate removal of the battery and may include but is not limited to a loop, a hook, a tab, a t-shaped or u-shaped member and the like. The handle (1475) may be attached to the battery (300) formed as an integral component of the battery (300) or attached to a battery box or other container in which the battery (300) is supported. In the example, handle (1475) includes a pair of generally U-shaped members located on either side of battery (300). The ends (1476) of each handle (1475) are pivotally attached to the battery (300) or box housing the battery so that they may lie flat when the battery (300) is in the cavity (55) and pulled upward when extracting the battery (300).

As shown in other embodiments, a battery box may be provided to house the battery and support it within chassis (30) in a manner where the battery box itself is moveable. For example, as shown in FIGS. 3-4, battery box may include a pair of guides that are slideably mounted within chassis to facilitate travel of the battery box to remove the battery. With reference to FIG. 7, a battery box (1480) may be supported on guides (1485) within cavity (55). Guides (1485) may be oriented vertically to move the battery box (1480) vertically to facilitate installation and extraction of the battery (300) via the upper opening in cavity (55).

Electrical connection of the battery to a control unit and in turn to the electric motor that power propulsion of the vehicle may be made as described above with appropriate routing of the cables within the chassis (1430).

### Examples

Example 1. A drive system for an all-terrain vehicle (ATV) comprising: an electric motor; at least three wheel and tire assemblies; a primary battery located within at least two opposing frame rails of a chassis of the all-terrain vehicle; a control module; and a throttle device; and wherein the electric motor is a three-phase electric motor; the electric motor is rotationally connected to at least one of the wheel and tire assemblies; the electric motor is electrically connected to, and configured to receive at least a first signal from the control module; the control module is electrically connected to, and configured to receive a charge from the primary battery; and the throttle device is electrically connected to, and configured to send a second signal to the control module.

Example 2. The drive system of example 1, wherein the electric motor is rotationally connected to at least two of the wheel and tire assemblies.

Example 3. The drive system of example 1, comprising four wheel and tire assemblies.

Example 4. The drive system of example 3, wherein the electric motor is rotationally connected to each of the four wheel and tire assemblies.

Example 5. The drive system of example 1, wherein the electric motor is rotationally connected to the wheel and tire assemblies by an electric motor gearbox which is rotationally connected to a driveshaft which is rotationally connected to a gearbox which is rotationally connected to an axle.

Example 6. The drive system of example 4, wherein the electric motor is rotationally connected to the wheel and tire assemblies by an electric motor gearbox which is rotationally connected to a driveshaft which is rotationally connected to a gearbox which is rotationally connected to an axle.

Example 7. The drive system of example 1, further comprising: at least one device selected from the group consisting of a light, a horn, and a winch; a step down converter; a secondary battery; and a transducer; and wherein the step down converter is electrically connected to, and configured to receive a charge from the secondary battery at a first voltage level; each device of the at least one device is electrically connected to, and configured to receive a signal from the step down converter at a second voltage level which is less than the first voltage level when a circuit between the device and the secondary battery is opened; and the transducer is electrically connected to the primary battery and the secondary battery to provide a recharging voltage to the secondary battery from the primary battery.

Example 8. The drive system of example 7, wherein the at least one device comprises at least one light selected from the group consisting of at least one headlight, at least one tail light, at least one brake light, at least one turn signal light, at least one daytime running light, and at least one fog light.

Example 9. The drive system of example 1, wherein the primary battery is contained within a housing, said housing having a first cuboid shape.

Example 10. The drive system of example 9, wherein the housing includes an extension protruding upward from a top surface of the first cuboid shape wherein said extension has a second cuboid shape.

Example 11. The drive system of example 9, wherein the chassis comprises a slideable drawer configured to receive the primary battery.

Example 12. The drive system of example 11, wherein the slideable drawer comprises a pair of opposing tracks.

Example 13. The drive system of example 12, wherein at least one of the pair of opposing tracks comprises a friction reducing mechanism.

Example 14. The drive system of example 13, wherein the friction reducing mechanism is at least one bearing.

Example 15. The drive system of example 13, wherein the friction reducing mechanism is at least one slide plate comprising a material selected from the group consisting of ultra high molecular weight polyethylene (UHMW) plastics, bronze, powdered metal, and Teflon®.

Example 16. The drive system of example 1, wherein the electric motor is rotationally connected to the wheel and tire assemblies by a gear and chain drive connected to an axle.

Example 17. The drive system of example 1, wherein the electric motor is rotationally connected to the wheel and tire assemblies by a belt and pulley drive connected to an axle.

Example 18. The drive system of example 1, wherein the primary battery is a lithium style battery.

Example 19. The drive system of example 1, wherein the primary battery is a lead acid battery.

Example 20. A chassis for an all-terrain vehicle (ATV), the chassis comprising a first frame rail and a second frame rail, where the first frame rail and second frame rail have a front end and a rear end separated by a saddle portion; where the front end and rear end extend downward relative to the saddle portion; the first frame rail and second frame rail being held in a spaced relationship relative to each other by at least on strut; where the first frame rail and second frame rail extend inward relative to each other as they extend downward from the saddle portion toward the front end; and wherein the first frame rail and second frame rail extend laterally outward relative to each other as they extend rearward of the saddle portion defining a rearward facing opening; a first cross support extending from the front end to the rear end of the first frame rail connecting the first frame rail below the saddle portion thereof, a second cross support extending from the front end to the rear end of the second frame rail connecting the second frame rail below the saddle portion; the first and second frame rails and first and second cross supports defining a cavity below the frame rails within the saddle portion thereof; a slidable drawer mounted within the cavity and slidable to extend rearward of the cavity through the opening to exit the rear of the chassis; wherein the slidable drawer holds a battery.

Example 21. The chassis of example 20, wherein the cross supports extend generally parallel to each other from the front end and beneath the saddle portion and extend laterally outward relative to each other from the saddle portion to the rear end of the chassis.

Example 22. The chassis of example 20, wherein the first cross support and second cross support extend rearward from front end and are located laterally inward of the first frame rail and second rail below at least a portion of the saddle portion formed by the first frame rail and second frame rail, and as the first cross support and second cross support extend rearward from the saddle portion, they extend laterally outward relative to each other passing under the first frame rail and second frame rail respectively; wherein a first strut extends upward and laterally outward from each of the first cross support and second cross support to connect to the first frame rail and second frame rail at the saddle portion; and a second strut extends upward vertically from each of the first cross support and second cross support where the first frame rail and second frame rail cross over the first cross support and second cross support.

Example 23. The chassis of example 20, further comprising at least one strut extending downward from the first frame rail to the first cross support and at least one strut extending downward from the second frame rail to the second cross support, wherein the at least one strut is adjacent to the cavity; a track assembly supported on the at least on struts on inward of the first frame rail and second frame rail, wherein the slidable drawer is slidably mounted on the track assembly.

Example 24. The chassis of example 20, further comprising bodywork attached to the chassis, the bodywork including a saddle mounted on the saddle portion; and at least one foot platform located below the saddle and laterally outward thereof.

Example 25. The chassis of example 20, further comprising an electric motor supported on at least one of the frame rails; the electric motor being electrically connected to the battery; a wheel and tire assembly coupled to the electric motor to cause rotation thereof.

Example 26. The chassis of example 20, further comprising a suspension subframe supported on the front end of the first and second frame rails; the suspension subframe supporting a front wheel and tire assembly; a handle bar coupled to the front wheel and tire assembly to provide steering input there to; a rear wheel and tire assembly rotatably supported on the rear end of the first and second frame rails; and a drive system supported on at least one of the first and second frame rails; the drive system including an electric motor, a control module and a throttle device, wherein the electric motor is rotationally connected to at least one of the wheel and tire assemblies; the electric motor is electrically connected to and configured to receive at least a first signal from the control module, the control module is electrically connected to and configured to receive a charge from the battery; and the throttle device is electrically connected to and configured to send a second signal to the control module.

Example 27. The chassis of example 26, wherein the front and rear wheel and tire assemblies include four wheels and the electric motor is connected to all four wheels.

Example 28. The chassis of example 20, further comprising at least one light supported on at least one of the first and second frame rails, wherein the at least one light is electrically connected to the battery.

Example 29. The chassis of example 20, further comprising at least one device, a step down converter, a secondary battery and a transducer; wherein the step down converter is electrically connected to, and configured to receive a charge from the secondary battery at a first voltage level; the at least one device is electrically connected to, and configured to receive a signal from the step down converter at a second voltage level which is less than the first voltage level when a circuit between the device and the secondary battery is opened; and the transducer is electrically connected to the battery and the secondary battery to provide a recharging voltage to the secondary battery from the battery.

Example 30. The chassis of example 29, wherein the device includes at least one of a light, a horn, and a winch.

Example 31. An all-terrain vehicle (ATV) comprising: a chassis, the chassis including a first frame rail and a second frame rail, the first frame rail and second frame rail having a front end, a saddle portion and a rear end, where the first frame rail and second frame rail are held in a laterally spaced relationship by at least one cross strut; the first frame rail and second frame rail extending downward from the saddle portion at the front end and rear end; a first cross support extending from the front end to the rear end of the first frame rail below the saddle portion; and a second cross support extending from the front end to the rear end of the second frame rail below the saddle portion; wherein the first and second frame rails and the first and second cross supports define a central cavity beneath the saddle portion and an opening rearward of the saddle portion between the first and second frame rails at the rear end; a slidable drawer slideably mounted within the cavity between a first position within the cavity and a second position extending outward of the rear end of the first and second frame rails; a battery housed within the slidable drawer and removable therefrom; a first wheel and tire assembly supported on the front end of the chassis and a second wheel and tire assembly supported on the rear end of the chassis; a first wheel and tire assembly supported on the front end of the chassis and a second wheel and tire assembly supported on the rear end of the chassis; a handle bar coupled to the first wheel and tire assembly to provide steering input thereto; and a saddle supported on the saddle portion of the chassis rearward of the handle bar.

Example 32 The all-terrain vehicle (ATV) of example 31, further comprising a secondary battery supported within the slidable drawer and connected to the controller, wherein the controller includes a transducer electrically connected to the battery to provide a recharging voltage from the secondary battery to the battery.

Example 33. The all-terrain vehicle (ATV) of example 31, further comprising a bodywork supported on the chassis, the bodywork including a nose having an opening therein configured to route air toward the battery.

Example 34. The all-terrain vehicle (ATV) of example 31, further comprising a bodywork supported on the chassis, wherein the bodywork includes at least one foot platform supported below the saddle and laterally outward thereof.

Example 35. A drive system for an all-terrain vehicle (ATV) comprising: an all-terrain vehicle chassis having at least two opposing side frame rails, a first horizontally extending strut at a forward end of the all-terrain vehicle chassis, and a second horizontally extending strut at a rear end of the all-terrain vehicle chassis, with a first length dimension of each of the side frame rails being greater than a second length dimension of the first horizontally extending strut and the second horizontally extending strut; an electric motor; at least three wheel and tire assemblies with at least two of the wheel and tire assemblies extending past opposing end points of the first horizontally extending strut and the second horizontally extending strut; a primary battery with at least a portion of said primary battery located within a battery compartment defined by the two opposing side frame rails, the first horizontally extending strut, and the second horizontally extending strut; a control module; and a throttle device connected to a handle bar; and wherein the electric motor is a three-phase electric motor, the electric motor is rotationally connected to at least one of the wheel and tire assemblies, the electric motor is electrically connected to and configured to receive at least a first signal from the control module, the control module is electrically connected to and configured to receive a charge from the primary battery, and the throttle device is electrically connected to and configured to send a second signal to the control module.

Example 36. The drive system of example 35, wherein the electric motor is rotationally connected to at least two of the wheel and tire assemblies.

Example 37. The drive system of example 35, wherein the electric motor is rotationally connected to the wheel and tire assemblies by an electric motor gearbox which is rotationally connected to a driveshaft which is rotationally connected to a gearbox which is rotationally connected to an axle.

Example 38. The drive system of example 35, wherein the primary battery is contained within a housing, said housing having a first cuboid shape.

Example 39. The drive system of example 35, wherein the primary battery is a lithium battery.

Example 40. A drive system for an all-terrain vehicle (ATV) comprising: an electric motor; a gearbox; a first differential; a second differential; four wheel and tire assemblies; a battery; a control module; and a throttle device; the electric motor is electrically connected to, and configured to receive at least a first signal from the control module; the control module is electrically connected to, and configured to receive a charge from the battery; and the throttle device is electrically connected to, and configured to send a second signal to the control module; the electric motor is rotationally connected to the gearbox, the first differential is rotationally connected to the gearbox; a drive shaft rotationally coupled to the gearbox opposite the first differential and extending to rotationally connect to the second differential, wherein the electric motor, gearbox and first differential are located near a first pair of the four wheel and tire assemblies and the second differential is located near a second pair of the four wheel and tire assemblies.

Example 41. A drive system for an all-terrain vehicle (ATV) comprising: an electric motor; a gearbox; four wheel and tire assemblies; a battery; a control module; and a throttle device; the electric motor is electrically connected to, and configured to receive at least a first signal from the control module; the control module is electrically connected to, and configured to receive a charge from the battery; and the throttle device is electrically connected to, and configured to send a second signal to the control module; the electric motor is rotationally connected to the gearbox, wherein at least one drive shaft is rotationally coupled to the gearbox to rotationally connect the gearbox to the four wheel and tire assemblies.

Example 42. The drive system of example 41 further comprising a first differential coupled to a first pair of the four wheel and tire assemblies, and a second differential coupled to a second pair of the four wheel and tire assemblies, wherein the gearbox is rotationally coupled to the first differential and second differential to rotationally connect to the four wheel and tire assemblies.

Example 43. The drive system of example 42 further comprising a chassis having a rear end supporting the first pair of the four wheel and tire assemblies and a forward end supporting the second pair of the four wheel and tire assemblies, the chassis including at least two frame rails that extend from the forward end to the rear end, the electric motor, gearbox and first differential being mounted between the frame rails and supported on the chassis at the rear end thereof; and the first differential being supported on the chassis at the forward end thereof.

Example 44. The drive system of example 42 further comprising a steering assembly, the steering assembly connected to the second pair of the four wheel and tire assemblies, wherein the second differential is supported within the chassis adjacent to the steering assembly near the second pair of the four wheel and tire assemblies.

Example 45. The drive system of example 43, wherein the steering assembly extends forward of the second differential to connect to the second pair of the four wheel and tire assemblies.

Example 46. The drive system of example 42, wherein a first pair of axles extends outward from the first differential to rotationally connect the first pair of the four wheel and tire assemblies to the first differential and a second pair of axles extends outward from the second differential to rotationally connect the second pair of the four wheel and tire assemblies to the second differential.

Example 47. The drive system of example 46, wherein each axle of the first pair of axles are rotationally connected to the first differential by a CV joint; and wherein each axle of the second pair of axles are rotationally connected to the second differential by a CV joint.

Example 48. The drive system of example 41, where the electric motor includes a motor shaft extending forward from the electric motor, wherein the gearbox is supported forward of the electric motor and coupled to the electric motor via the motor shaft, wherein the motor shaft is at least partially received within the gearbox.

Example 49. The drive system of example 42, where the first differential is located below the electric motor.

Example 50. The drive system of example 42, where the first differential is integral with the gearbox and extends rearward therefrom.

Example 51. The drive system of example 41 further comprising a first differential rotationally connected to the gearbox, the first differential being rotationally coupled to a first pair of the four wheel and tire assemblies; wherein the electric motor and gearbox are located near the first pair of the four wheel and tire assemblies and the at least one drive shaft extends toward a second pair of the four wheel and tire assemblies, wherein the at least one drive shaft extends between the gearbox and the second pair of the four wheel and tire assemblies.

Example 52. The drive system of example 51 wherein the electric motor is located above the first differential and extends parallel to the first differential, and wherein the gearbox extends is located on one side of the electric motor and the first differential coupling the electric motor and differential together.

Example 53. The drive system of example 52 further comprising a chassis, the chassis including a saddle support located between the first and second pair of wheel and tire assemblies, a steering assembly supported on the chassis forward of the saddle portion, wherein the battery is supported within the chassis between the saddle support and the steering assembly.

Example 54. The drive system of example 51 further comprising a chassis, the chassis including a saddle support located between the first and second pair of wheel and tire assemblies, a steering assembly supported on the chassis forward of the saddle portion, wherein the battery is supported within the chassis between the saddle support and the steering assembly.

Example 55. The drive system of example 54, wherein the chassis defines an opening between the steering system and the saddle support opening upward providing access to the battery.

Example 56. The drive system of example 55 wherein the battery is removable from the chassis via the opening.

Example 57. The drive system of example 56 further comprising at least one handle attached to the battery and extending upward toward the opening.

Example 58. The drive system of example 57, wherein the at least one handle is pivotally attached to the battery.

Example 59. A drive system in an electrically driven all-terrain vehicle comprising: an electric motor rotationally connected to a gearbox; a drive system comprising four propulsion assemblies; a first differential rotationally connected to two of the four propulsion assemblies and a second differential rotationally connected to the other two of the four propulsion assemblies; wherein the first differential is rotationally connected to the gearbox; and a drive shaft rotationally connected to the gearbox and extending therefrom to connect to the second differential.

Example. 60. A drive system for an electrically drive all-terrain vehicle comprising: an electric motor; a battery; a gearbox; a first differential; a second differential; a first pair of wheel and tire assemblies; and a second pair of wheel and tire assemblies; and a drive shaft; wherein the electric motor is electrically connected to the battery, the electric motor including a motor shaft that extends outward from the electric motor and is at least partially received in the gearbox and coupled thereto to rotationally connect the electric motor to the gearbox; the gearbox is rotationally coupled to the first differential on one side and the drive shaft on an opposite side; wherein the drive shaft extends from the gearbox to the second differential to rotationally couple the gearbox to the second differential; the first differential being rotationally coupled to the first pair of wheel and tire assemblies by a first pair of axles extending outward therefrom; and the second differential being rotationally coupled to the second pair of wheel and tire assemblies by a second pair of axles extending outward therefrom; the drive assembly further comprising a chassis supporting the electric motor, the gearbox and the first differential in a rearward end thereof; the chassis supporting the second differential at a forward end thereof and the drive shaft extending forward from the gearbox to the forward end; the chassis including a first suspension subframe at the rearward end, wherein the electric motor, gearbox and first differential are mounted on the chassis above the first suspension subframe; the chassis further includes a second suspension subframe at a forward end, wherein the second differential is mounted above the second suspension subframe; and wherein the chassis includes a saddle portion at the rearward end that extends forward of the gearbox toward the forward end and a steering assembly spaced forward from the saddle portion, and wherein the chassis defines a cavity between the saddle portion and the steering assembly that opens upwardly, wherein the battery is removably mounted within the cavity and accessible through the opening.

Example 61. The drive system of example 55, wherein the battery is removably supported within the chassis in a battery box.

Example 62. The drive system of example 61, wherein the battery box is supported within the chassis on at least one vertically oriented guide and wherein the battery box is moveable on the guide through the opening.

Specific examples of an innovation are disclosed herein, but these examples are not limiting. One of ordinary skill in the art will readily recognize that the innovation may have other applications in other environments. In fact, many embodiments and implementations are possible. The following claims are in no way intended to limit the scope of the subject innovation to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the subject innovation has been shown and described with respect to a certain preferred embodiment or embodiments, equivalent alterations and modifications will occur to others skilled in the art upon the reading and understanding of this specification and the annexed drawings. In particular regard to the various functions performed by the above described elements (e.g., enclosures, sides, components, assemblies, etc.), the terms (including a reference to a “means”) used to describe such elements are intended to correspond, unless otherwise indicated, to any element which performs the specified function of the described element (e.g., that is functionally equivalent), even though not structurally equivalent to the disclosed structure which performs the function in the herein illustrated exemplary embodiment or embodiments of the innovation. In addition, while a particular feature of the innovation may have been described above with respect to only one or more of several illustrated embodiments, such feature may be combined with one or more other features of the other embodiments, as may be desired and advantageous for any given or particular application. Although certain embodiments have been shown and described, it is understood that equivalents and modifications falling within the scope of the appended claims will occur to others who are skilled in the art upon the reading and understanding of this specification.

In addition, while a particular feature of the subject innovation may have been disclosed with respect to only one of several implementations, such feature may be combined with one or more other features of the other implementations as may be desired and advantageous for any given or particular application. As used herein, spatially orienting terms such as “above,” “below,” “upper,” “lower,” “inner,” “outer,” “right,” “left,” “vertical,” “horizontal,” “top,” “bottom,” “upward,” “downward,” “laterally,” “upstanding,” et cetera, can refer to respective positions of aspects as shown in or according to the orientation of the accompanying drawings. “Inward” is intended to be a direction generally toward the center of an object from a point remote to the object, and “outward” is intended to be a direction generally away from an internal point in the object toward a point remote to the object. Such terms are employed for purposes of clarity in describing the drawings, and should not be construed as exclusive, exhaustive, or otherwise limiting with regard to position, orientation, perspective, configuration, and so forth.

Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements. For an understanding of the scope of the invention, reference is made to the following claims.

1. A drive system for an all-terrain vehicle (ATV) comprising: an electric motor; a gearbox; four wheel and tire assemblies; a battery; a control module; and a throttle device; the electric motor is electrically connected to, and configured to receive at least a first signal from the control module; the control module is electrically connected to, and configured to receive a charge from the battery; and the throttle device is electrically connected to, and configured to send a second signal to the control module; the electric motor is rotationally connected to the gearbox, wherein at least one drive shaft is rotationally coupled to the gearbox to rotationally connect the gearbox to the four wheel and tire assemblies.

2. The drive system of claim 1 further comprising a first differential coupled to a first pair of the four wheel and tire assemblies, and a second differential coupled to a second pair of the four wheel and tire assemblies, wherein the gearbox is rotationally coupled to the first differential and second differential to rotationally connect to the four wheel and tire assemblies.

3. The drive system of claim 2 further comprising a chassis having a rear end supporting the first pair of the four wheel and tire assemblies and a forward end supporting the second pair of the four wheel and tire assemblies, the chassis including at least two frame rails that extend from the forward end to the rear end, the electric motor, gearbox and first differential being mounted between the frame rails and supported on the chassis at the rear end thereof; and the first differential being supported on the chassis at the forward end thereof.

4. The drive system of claim 2 further comprising a steering assembly, the steering assembly connected to the second pair of the four wheel and tire assemblies, wherein the second differential is supported within the chassis adjacent to the steering assembly near the second pair of the four wheel and tire assemblies.

5. The drive system of claim 4, wherein the steering assembly extends forward of the second differential to connect to the second pair of the four wheel and tire assemblies.

6. The drive system of claim 2, wherein a first pair of axles extends outward from the first differential to rotationally connect the first pair of the four wheel and tire assemblies to the first differential and a second pair of axles extends outward from the second differential to rotationally connect the second pair of the four wheel and tire assemblies to the second differential.

7. The drive system of claim 6, wherein each axle of the first pair of axles are rotationally connected to the first differential by a CV joint; and wherein each axle of the second pair of axles are rotationally connected to the second differential by a CV joint.

8. The drive system of claim 1, where the electric motor includes a motor shaft extending forward from the electric motor, wherein the gearbox is supported forward of the electric motor and coupled to the electric motor via the motor shaft, wherein the motor shaft is at least partially received within the gearbox.

9. The drive system of claim 2, where the first differential is located below the electric motor.

10. The drive system of claim 2, where the first differential is integral with the gearbox and extends rearward therefrom.

11. The drive system of claim 1, further comprising a first differential rotationally connected to the gearbox, the first differential being rotationally coupled to a first pair of the four wheel and tire assemblies; wherein the electric motor and gearbox are located near the first pair of the four wheel and tire assemblies and the at least one drive shaft extends toward a second pair of the four wheel and tire assemblies, wherein the at least one drive shaft extends between the gearbox and the second pair of the four wheel and tire assemblies.

12. The drive system of claim 11 wherein the electric motor is located above the first differential and extends parallel to the first differential, and wherein the gearbox extends is located on one side of the electric motor and the first differential coupling the electric motor and differential together.

13. The drive system of claim 12 further comprising a chassis having a forward end and a rear end, wherein a first pair of the four wheel and tire assemblies are supported on the chassis at the rearward end and a second pair of the four wheel and tire assemblies are supported on the chassis at the forward end; wherein the electric motor, gearbox and first differential are supported within the chassis at the rearward end, a pair of axles extending outward from the first differential to rotationally connect the first pair of the four wheel and tire assemblies to the electric motor, wherein the electric motor is mounted over the pair of axles.

14. The drive system of claim 1 further comprising a chassis, the chassis including a saddle support located between the first and second pair of wheel and tire assemblies, a steering assembly supported on the chassis forward of the saddle portion, wherein the battery is supported within the chassis between the saddle support and the steering assembly.

15. The drive system of claim 14, wherein the chassis defines an opening between the steering system and the saddle support opening upward providing access to the battery.

16. The drive system of claim 15 wherein the battery is removable from the chassis via the opening.

17. The drive system of claim 16 further comprising at least one handle attached to the battery and extending upward toward the opening.

18. The drive system of claim 17, wherein the at least one handle is pivotally attached to the battery.

19. A drive system in an electrically driven all-terrain vehicle comprising: an electric motor rotationally connected to a gearbox; a drive system comprising four propulsion assemblies; a first differential rotationally connected to two of the four propulsion assemblies and a second differential rotationally connected to the other two of the four propulsion assemblies; wherein the first differential is rotationally connected to the gearbox; and a drive shaft rotationally connected to the gearbox and extending therefrom to connect to the second differential.

20. A drive system for an electrically drive all-terrain vehicle comprising:
an electric motor; a battery; a gearbox;
a first differential;
a second differential;
a first pair of wheel and tire assemblies and a second pair of wheel and tire assemblies; and
a drive shaft;
wherein the electric motor is electrically connected to the battery, the electric motor including a motor shaft that extends outward from the electric motor and is at least partially received in the gearbox and coupled thereto to rotationally connect the electric motor to the gearbox;
the gearbox is rotationally coupled to the first differential on one side and the drive shaft on an opposite side; wherein the drive shaft extends from the gearbox to the second differential to rotationally couple the gearbox to the second differential; the first differential being rotationally coupled to the first pair of wheel and tire assemblies by a first pair of axles extending outward therefrom; and
the second differential being rotationally coupled to the second pair of wheel and tire assemblies by a second pair of axles extending outward therefrom;
the drive assembly further comprising a chassis supporting the electric motor, the gearbox and the first differential in a rearward end thereof;
the chassis supporting the second differential at a forward end thereof and the drive shaft extending forward from the gearbox to the forward end;
the chassis including a first suspension subframe at the rearward end, wherein the electric motor, gearbox and first differential are mounted on the chassis above the first suspension subframe; the chassis further includes a second suspension subframe at a forward end, wherein the second differential is mounted above the second suspension subframe; and wherein the chassis includes a saddle portion at the rearward end that extends forward of the gearbox toward the forward end and a steering assembly spaced forward from the saddle portion, and wherein the chassis defines a cavity between the saddle portion and the steering assembly that opens upwardly, wherein the battery is removably mounted within the cavity and accessible through the opening.
